(19) United States
(12) Patent Application Publication
(10) Pub. No.: US 2010/0029326 A1
(43) Pub. Date: Feb. 4, 2010

(54) WIRELESS DATA CAPTURE AND SHARING SYSTEM, SUCH AS IMAGE CAPTURE AND SHARING OF DIGITAL CAMERA IMAGES VIA A WIRELESS CELLULAR NETWORK AND RELATED TAGGING OF IMAGES

(76) Inventors: Jonathan Bergstrom, Seattle, WA (US); Mark Drovdahl, Seattle, WA (US); Sinclair Temple, Seattle, WA (US)

Correspondence Address: PERKINS COIE LLP;PATENT-SEA, P.O. BOX 1247, SEATTLE, WA, 98111-1247, US

(21) Appl. No.: 12/182,952

(22) Filed: Jul. 30, 2008

(51) Int. Cl. H04M 1/00; H04B 7/02

(52) U.S. Cl. 455/556.1; 455/41.2

(57) ABSTRACT

Described in detail herein are systems and methods for allowing a wireless telecommunications device, such as a cell phone, to wirelessly receive and transmit digital content, such as digital images from a digital camera or camcorder. Further, the wireless telecommunications device or user computer can automatically receive metadata or tags to be associated with the digital content. Further details and features are described herein.

### CROSS-REFERENCE TO RELATED APPLICATION

This application is related to the assignee's concurrently filed U.S. application Ser. No. ______, entitled “WIRELESS DATA CAPTURE AND SHARING SYSTEM, SUCH AS IMAGE CAPTURE AND SHARING OF DIGITAL CAMERA IMAGES VIA A WIRELESS CELLULAR NETWORK” (Attorney Docket No. 31419.8052).

### BACKGROUND

Digital image capture devices, such as digital cameras or camera phones, are ubiquitous. However, billions of digital photographs are “trapped” each year on cameras or personal computers as consumers struggle to share those photos with others. Some web sites have become available to allow users to share their photos, such as Flickr, Picasa, Kodak Gallery, and so forth. These sites, however, require a user to take a set of photos, download them to a personal computer, upload them to a photo-sharing web site, and then provide a notification (such as an email) and authorization for third parties to access and view those photos.

Backwards compatible Secured Digital Input/Output cards (SDIO cards) are now available to help in the photo-sharing process. For example, the Eye-Fi card is an SDIO card that includes semiconductor memory and an IEEE802.11 radio. The card may be inserted into a camera, where images taken by the camera are stored on the card. The radio on the card then allows the user to wirelessly transmit these images to a user's personal computer or web site.

One problem with such a card is that it may be difficult to implement, particularly for users very inexperienced with computers or digital equipment. Further, a user must ensure that her digital camera can accept a particular memory card. Moreover, the user must have a personal computer and be sufficiently knowledgeable in use of that computer in order to use the card. Thus, the ability to serve a variety of people or equipment, tag images, or otherwise manage images is needed.

Another problem is that users often wish to “tag” their image or associate images with certain metadata. Such metadata or tags can help the user organize or locate images. Further, such metadata can be used by third parties, such as for targeting advertising. However, the process for providing tags to images can be time consuming and inaccurate.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a system diagram illustrating a suitable implementation of aspects of the invention.

FIG. 2 is a block diagram illustrating a camera wirelessly linked with a mobile phone.

FIG. 3 is a flow diagram illustrating a process for wirelessly routing images from a camera, through the mobile phone, to a network location.

FIG. 4 is a block diagram illustrating a memory card with wireless capabilities and associated software.

FIG. 5 is a flow diagram illustrating an example of adding metadata or tags to digital content, such as photos, received at a phone, where the tags relate to nearby individuals, locations or devices.

FIG. 5 is a flow diagram illustrating an example of adding metadata or tags to digital content.

FIG. 6 is a flow diagram illustrating an example of a process for automatically tagging photos with calendar data.

FIG. 7 is a flow chart showing an example of a process for automatically tagging photos with location data.

FIG. 8 is a flow chart showing an example of a process for associating rules or other actions with based-on tagged photos.

FIG. 9 is a representative screenshot illustrating a graphical user interface to manage the handling of digital images under the system of FIG. 1.

FIG. 10 is a representative screenshot illustrating a graphical user interface on a mobile phone for tagging digital images.

The headings provided herein are for convenience only and do not necessarily affect the scope or meaning of the claimed invention.

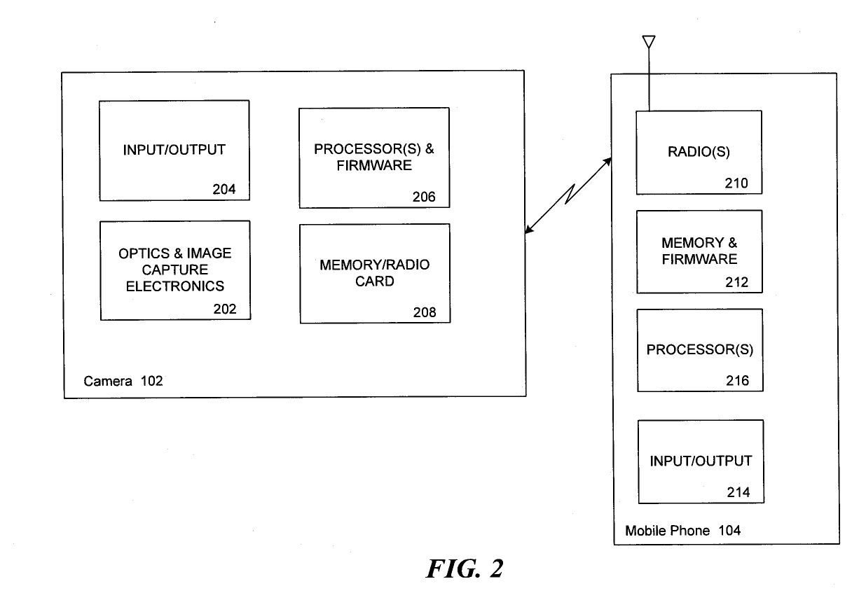

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION

As described herein, a system permits the sharing of digital content, such as digital images, using a wireless mobile device operating within a wireless network. The wireless device automatically receives captured images under a short-range wireless protocol (e.g., Bluetooth or WiFi), which differs from that of the cellular network. The wireless device is logically associated with (e.g., “paired”) with a digital content capture device (e.g., digital camera). The wireless device may automatically forward the digital content (e.g. digital image files) to a predetermined network destination (e.g., a URL), without contemporaneous human interaction with the mobile telecommunications device. Further, metadata or tags may be associated with the captured digital content to provide captions, annotations or other descriptive data associated with that content. Such tags can be automatically provided to the digital content often soon after the content is captured, and conveniently on a user's mobile device.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

### System Description

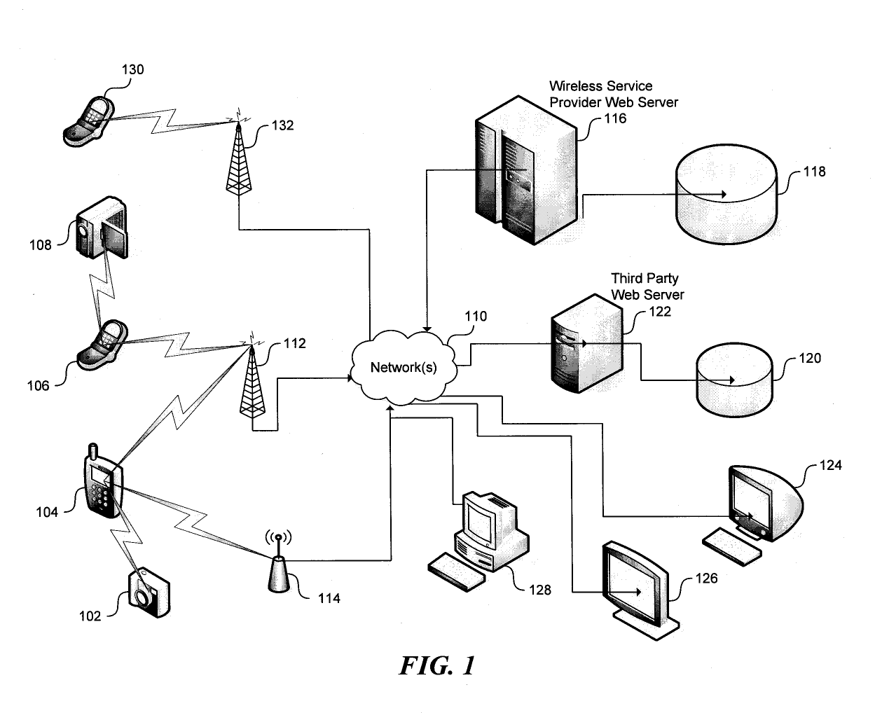

FIG. 1 and the following discussion provide a brief, general description of a suitable environment in which the invention can be implemented. Although not required, aspects of the invention are described below in the general context of computer-executable instructions, such as routines executed by a general-purpose data processing device, e.g., a server computer, wireless device or personal computer. Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

As shown in FIG. 1, a digital capture device, in this case a digital camera 102, is wirelessly connected to a wireless telecommunications device, in this case a cellular phone or smartphone 104. Likewise, a cellular phone 106 is wirelessly connected to a video camera or other video-capture device 108. The phones 104, 106 in turn may wirelessly communicate with a network 110 via one or more cellular transceiver(s) or base station(s) 112 within a cellular telecommunications network or other wireless telecommunications network. The cellular telecommunications network may operate at any known standard, such as GSM, CDMA, GPRS, EDGE, UMTS, etc. While the term “phone” is used herein, any wireless telecommunications device capable of performing the functions described herein may be used.

Alternatively or additionally, a wireless telecommunications device, such as phone 104, may communicate with the network 110 via a wireless local area network (WLAN), via a wireless access point (AP) or hotspot 114. The wireless AP 114 may use any known wireless communication protocols, such as IEEE 802.11 or IEEE 802.16. The phone 104 can communicate with the network via the AP 114 via the Unlicensed Mobile Access (UMA) or the Generic Access network (GAN) protocol. The AP 114 typically has a wireless range that is less than that of cellular transceiver 112, but in some embodiments, for instance 802.16 or Wimax, the wireless range may be equal to or exceed that of cellular transceiver 112.

As explained in more detail below, pictures or videos provided by cameras 102, 108 may be wirelessly transmitted to the network 110 via phones 104, 106, where such phones effectively act as modems to pass through the digital content. The network 110 may in turn route the content to a pre-determined location, such as one identified by a Universal Resource Locator (URL). For example, the network may route the images to a web server 116 determined by the user's wireless service provider. The web server 116 in turn stores those images in a database 118, as described below. Likewise, the content may be stored directly in a third-party database 120 associated with a third-party web server 122, rerouted to database 120 by web server 116, or forwarded directly and in real-time by web server 116 or third party web server 122 to remote content recipients such as by streaming content.

The user may access the images stored in databases 118 or 120 via a personal computer 124. The images may also be displayed on an electronic picture frame 126 or a similar display device, or accessed by a third party on a third-party computer 128 (typically when first authorized by the user). Likewise, the images may be displayed on a third-party mobile device 130, which may be on a different cellular network 132.

As described in more detail below, the system automatically gathers tags that may be associated with digital content such as photos. Upon receiving the photos, the system can query the user whether to add the tags to the photos. While described generally below as receiving images at the mobile phone 104 and providing a query to the user at that phone, the servers 116 or 122 can provide the user with such a query at the user computer 124. With the images stored in one or more databases 118 or 120, with their associated tags, the servers then may make use of those tags, such as permitting the user to organize photos by tags, create photo albums to be printed, and so forth. Such tags could also be used to provide targeted advertising to the user or others.

### Phone-Camera Pair

Referring to FIG. 2, the camera 102 may be a standard digital camera that includes optics and image capture electronics 202 and input/output components 204, all connected to communicate with one or more processors operating firmware 206. The input/output components may include various buttons or user controls, one or more display screens, audio input and/or output devices, etc. As described more fully below, the camera may also include a removable memory card that includes a wireless radio 208. Of course, the camera may instead include a fixed wireless radio. The removable memory card is received within a card slot of the camera, and can be of a form and shape common to any known cards, such as SD cards, xD cards, PCMCIA cards, etc.

The camera 102 can wirelessly communicate directly or via radio card 208 with a mobile telecommunications device, such as mobile phone 104, which includes one or more radios 210, memory and firmware 212 and input/output components 214 that all communicate with one or more processors 216. The radios can include a CDMA, GSM, GPRS, EDGE or UMTS radio, or prospective 4G technologies such as LTE, as well as a WLAN, and/or personal area network (PAN) radio, such as one employing IEEE 802.11, Bluetooth or other wireless standards. In the example of FIGS. 1 and 2, the camera and phone communicate with each other over a short-range wireless link using any known short-range protocol. Such short-range protocol typically has a range of about 10-50 meters (often under 100 meters), and includes Piconet protocols, including ZigBee, IrDA, and Ultra Wide Band (UWB).

The processors in the phone, the camera or both can include digital signal processors or other components for processing images, facilitating voice and data calls, as well as processors for performing actions described herein. The input/output components of the phone 104 include a microphone, speaker, visual display, user input buttons, as well as other components, such as a global positioning system (GPS), a digital camera, and so forth. While the phone 104 may have its own digital camera, the camera 102 is typically designed specifically for taking higher quality digital images, and thus may have a much higher resolution digital imager, better optics, and so forth. In GSM embodiments, both the phone 104 and the camera 102 may include a removable card slot to receive a Subscriber Identity Module (SIM) as well as a removable memory card that may itself include a radio, as noted herein.

### Representative Image Transfer Process

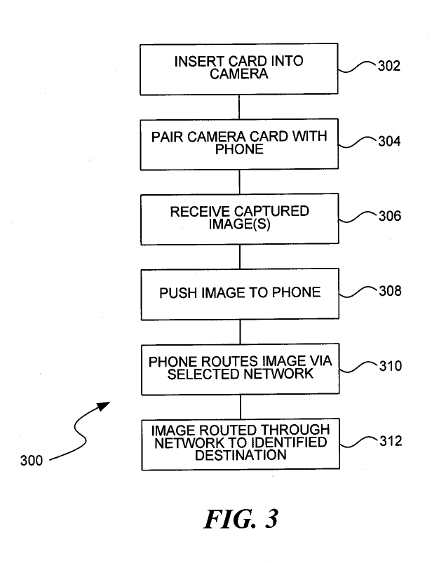

Referring to FIG. 3, a routine 300 performed by the system in FIG. 1 includes, in embodiments that include a radio card 208, initially inserting the radio card 208 into the camera 102 if the camera lacks a wireless link (block 302). The phone 104 then pairs itself with the radio card 208, such as using standard Bluetooth pairing. If the camera 102 has radio functionality, the phone 104 can pair with the camera 102 directly. Indeed, the camera/radio card and phone may use any of various Bluetooth profiles, such as the Dial-Up Networking (DUN) or Personal Area Network (PAN) profiles. As a result, the camera/radio card and phone are thereafter paired or linked so that secure communications may be exchanged between the two (block 304). More importantly, the camera, using firmware stored in the camera or within the removable memory/radio card 208, can automatically route digital pictures from the camera to the network and elsewhere via the phone 104.

After receiving a captured image (block 306), the camera, via its radio, transmits the image to the phone 104 (block 308) either by pushing the image to the phone or by responding to a phone request for the image. The phone and/or the camera/radio card may encapsulate network routing information or address with the image. For example, the camera (or phone) may add a header to the digital image to route the image to the user's personalized photo album at an Internet site or URL. Thus, the header can take the form of, for example, “http://www.T-Mobile.com/My Album [user ID].” The user ID may include any unique identifier for the user, such as the user's mobile identification number (MIN), International Mobile Subscriber Identifier (IMSI), International Mobile Equipment Identifier (IMEI), Secret Serial Number (SSN), phone number, Medium Access Control (MAC) address, Globally Unique Identifier (GUID), or any other identifier.

Firmware in the radio card 208 of the camera 102, or in memory 212 of the phone 104 can include a preprogrammed address, as well as instructions, for transmitting the digital image. The address can be a TCP/IP address, with a place for the user, wireless service provider, or other to insert the user's specific identifier. There may also be provisioning for the user, service provider, or other to insert aspects of the address.

The phone routes the image via a selected network (block 310), which can include a cellular telephone network (like CDMA, GSM, GPRS, EDGE, UMTS, or prospective networks such as LTE), or via a local area network employing IEEE 802.11, Bluetooth or other wireless standards. The phone may select the best or preferred network based on any of a variety of criteria, such as availability, signal strength, data transmission cost, and so forth. Indeed, the system can use any type of protocol or transport mechanism, including the Wireless Application Protocol (WAP), Multimedia Message Service (MMS), HyperText Transfer Protocol (HTTP), and so forth. Once received by the network 110, the network routes the images to the specified destination, such as to the web server 116 for storage and database 118 (block 312).

Overall, the image may be routed to any TCP/IP address, which the network 110 then routes to the appropriate destination, such as web server 116. A wireless telecommunications service provider may provide a web site for the user and is typically a media gateway to enable users to manage their photos from a central location. The web server acts as an intelligent intermediary for the digital image gateway and user manipulation of photos. As explained herein, the web server 116 may then in turn relay one or more received images to a third-party web server 122. Such third-party web servers may be any of various image storing and sharing sites, including Flickr, Facebook, and Picasa. The user can then go to the one or more web sites to access and manage his or her photos, as described herein.

Further, the user can access a predefined network location (accessible via the Internet) to rename his or her photo home page (e.g., changing it from some arbitrary, but unique, numeric value, to one more personalized to the user's tastes, like “www.T-Mobile.com/MyPhotos/00124758” to “www.T-Mobile.com/MyPhotos/Chrissy's RomePictures”). Of course, the images can also be transferred or copied to another site, even to the user's home computer. Further, as noted below, when the user accesses her pictures at her photo home page, the server 116 may query her whether to add or associate automatically obtained descriptive data, metadata or tags with newly added photos.

sRadio-Memory Card

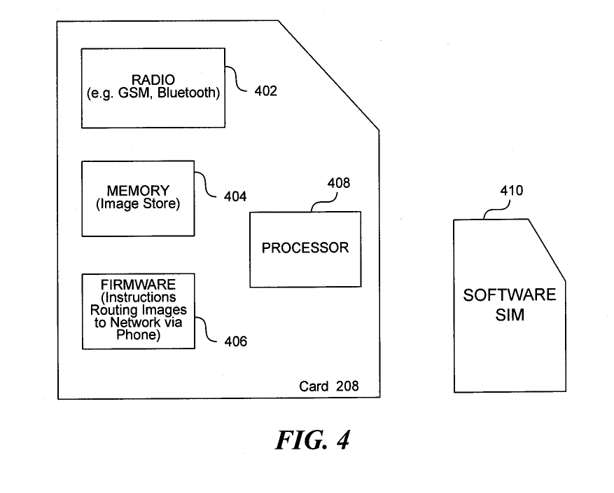

Referring to FIG. 4, the card 208 in the camera 102 may include a radio or wireless transceiver 402, semiconductor memory 404 and firmware 406, all carried or secured to some substantially rigid substrate or other member. As noted above, the radio can be of any form, but in this example is a Bluetooth radio. Alternatively or additionally, the radio can be configured to operate using other protocols, including more powerful protocols such as GSM, GPRS, EDGE, UMTS or CDMA, or prospective protocols like LTE. If a GSM or related protocol, the camera 102 may include, either stored in the memory 404 or elsewhere on the camera, a hardware or software SIM 410 to permit communications over the relevant network. The camera thus acts like a phone on the network, even if it is not configured for voice communications. The camera nevertheless can provide for real time communications, including photo-sharing, as described herein.

The memory 404 can be any semiconductor memory to permit the storing of photos. Notably, this memory need not be as large as is typical with digital camera memory, because the camera need not store images locally. Instead, with the wireless link, the camera can store photos elsewhere, such as in databases 118 or 120. The memory 404, if implemented, simply acts more like a buffer. If not implemented, the radio card 208 acts as a transceiver for transmitting captured content (in this case, digital images) in real time to the phone 104.

The firmware 406 includes instructions performed by processor 408 to permit the camera to automatically and wirelessly send digital content. When the card 208 is inserted in the camera 102, the camera 102 simply recognizes it as a memory card. However, whenever images are stored in the memory 404, the processor 408, operating on instructions stored in the firmware 406, transfers images from the memory to the phone 104 when the phone 104 is paired to and within range of the radio card 208. As noted above, the firmware includes an address that the processor includes with each image so that the image is routed appropriately via the network 110. The firmware may also include instructions to gather any relevant metadata to be associated with the images, such as timestamps, location data (e.g. from a GPS receiver), environmental data, etc.

### Representative Processes for Tagging Digital Content

As noted above, the system can associate descriptive data with captured digital content. For example, the digital camera 102 or camcorder 108 may capture digital content and forward it to the mobile phone 104, 106, and that phone may then automatically tag the digital content with metadata that describes the captured digital content. As described below, the system can automatically suggest tags to the user, and whether to add such tags to the digital content. In general, the terms “tag,” “metadata” and related terms refer to any data that relates to capture digital content (still images, video, audio, etc.). For example, the tags may indicate the names of individuals in pictures, the name of an event when a video was taken, or the name of a location when a digital audio clip was captured.

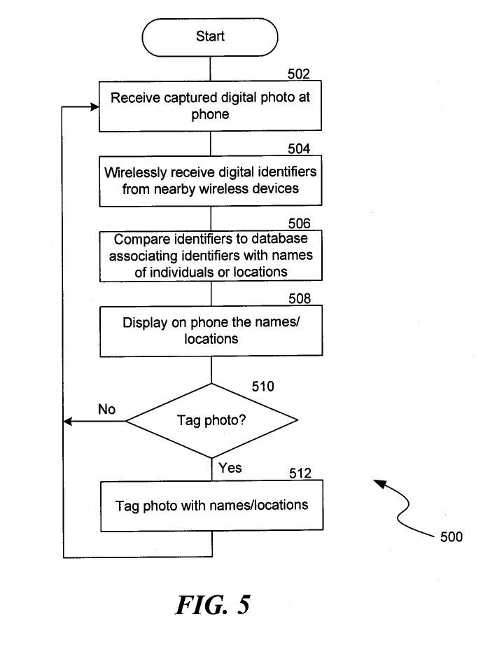

Referring to FIG. 5, an example of a routine 500 for automatically adding metadata or tags to digital photos or other digital content begins in block 502 where the phone 104 receives, for example, a digital photo from the camera 102. In block 504, the phone 104 also wirelessly receives digital identifiers from nearby wireless devices. For example, the camera 102 may take a picture of two people, each of whom has with them a wireless mobile device with a Bluetooth radio. The Bluetooth radio in turn transmits its unique identifier, which is received by the radio 210 of the phone 104. (While Bluetooth radios/transceivers are used in this example, standard mobile telephone transceivers, e.g. GSM transceivers, may be used to wirelessly provide and receive data.) Alternatively or additionally, the phone may wirelessly obtain digital identifiers from other wireless devices, including a cell site ID or fixed wireless transmitters that periodically transmit their identifiers.

In block 506, the phone 104 compares the received identifier to a database that associates identifiers with names of individuals or locations. For example, the memory 212 of the phone may include a contact list that includes the names of the two people whose picture has just been taken, along with the Bluetooth identifiers for them. Alternatively or additionally, the phone may route the received identifiers to, for example, the server 116 (via the network 110), and the server in turn queries the database 118 to determine the names associated with the received Bluetooth addresses. The server and database 118 can, of course, provide much greater access to names, locations, etc., associated with particular IDs than can the phone. In another example, the camera may obtain the cell site ID, and pass that to the network, which responds in turn with a geographic or location name for the cell site, which can include a neighborhood, building, etc.

In block 508, the phone 104 displays the names, locations or other data obtained based on the comparison of identifiers, and asks the user whether she would like to tag the photos with those names/locations. If she responds affirmatively (block 510), then the phone automatically tags the photos with the names, locations or other data under block 512. While described generally above as associating names or locations with a digital photo, the system can, of course, associate any data with a given photo where that data is matched with an appropriate identifier wirelessly received by the phone.

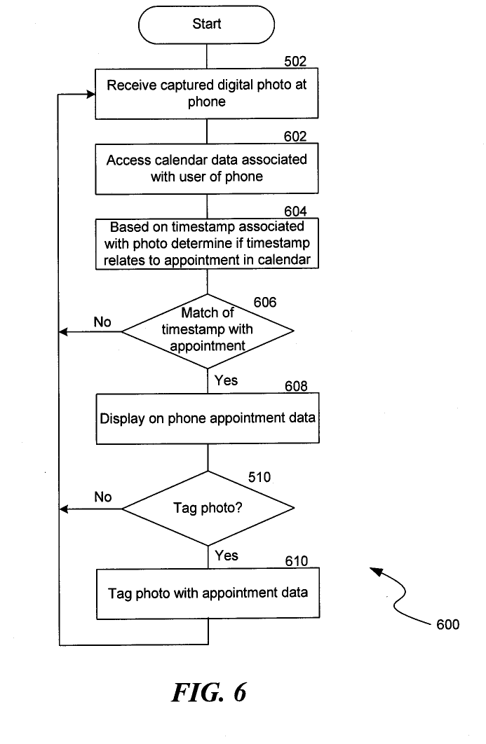

Further, the system can associate with photos appointment or calendar data from an electronic calendaring application, such as Microsoft® Outlook®. Referring to FIG. 6, a routine 600 for associating appointment data or tags with digital photos begins when the phone receives additional photo (block 502) and accesses calendar data (block 602). The phone may have stored on it a calendaring application with associated calendaring data and can thus access such data directly. However, the phone may also access calendaring data stored remotely, such as in databases 118, 120, or user computer 124. Either way, APIs provide access to such data for the routine 600.

In block 604, the phone determines whether a time stamp associated with the digital image, indicating when the image was taken, corresponds to an appointment in the calendar. If there is a match (block 606), then in block 608 the phone displays the appointment data and a query to the user. If the user decides to tag the photo with the appointment date (block 510), then the phone associates the appointment or calendar data with the image (block 610).

As a result, an appointment in the user's calendar may relate specifically to photos that have been taken at that time. For example, the user may have an appointment “Max's birthday” or “Shop at Market” and a time stamp of the photos correspond to that appointment time, and thus the photos may be associated with that appointment.

In another example, the user can tag photos with location data. Some cameras include a GPS receiver so that photos may be automatically associated with location metadata indicating where the photo was taken (as well as a clock time stamp for when the photo was taken). Mobile phones likewise include technology to determine their location, and thus, if the phone receives a photo without location data, the phone may generate its own location data and associate it with a photo. Then, using reverse geographical location processing (converting latitude and longitude to a location name), an appropriate location name can be related to the photo to indicate where the photo was taken (e.g., at the “Pike Place Market,” as opposed to at latitude 47.36 N, longitude 122.20 W).

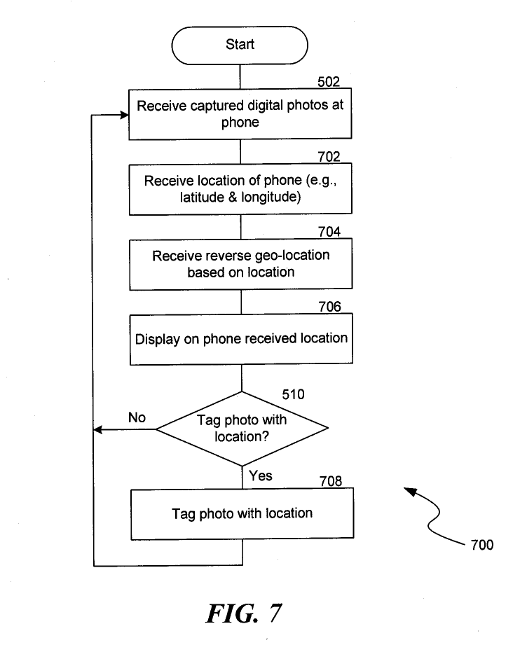

Referring to FIG. 7, a process 700 for attaching location tags to a digital photo begins when the phone receives a digital photo (block 502), and then receives location data, such as latitude and longitude via GPS (block 702). In block 704, the phone receives a reverse geo-location location name based on the latitude and longitude data. For example, the phone may provide the latitude and longitude or other global positioning or global information data to a server via the network 110, which maps the latitude and longitude to map data to provide back a location corresponding to the latitude and longitude. The location data can include a city, neighborhood, building, address, point of interest (e.g., park, monument, etc.), store name, and so forth.

In block 706, the phone displays the received location name to the user, and queries the user whether to tag the photo with the location data (block 510). If the user responds affirmatively, then the phone tags the photo with the location name (block 708).

Overall, some or all of the actions described above for the processes of FIGS. 5-7 are performed by the phone. Alternatively or additionally, some of these actions may be performed by an external device, such as a network server accessed by the phone via the network 110. The phone may first attempt to perform the action locally, and if it fails, then contact the server. For example, the phone may access a local contact database or calendar, and if no match is found, access another contact database or calendar stored remotely.

While digital photos are generally described herein in the examples, the processes apply equally to any other digital content, such as digital videos or digital audio content. Further, once tags are associated with the digital content, they may be stored together on the mobile phone, or wirelessly transmitted to the network for storage on the database 118, user computer 125, etc.

In addition to automatically tagging photos or other digital content with certain descriptive data or metadata, the system can analyze such tags and automatically perform certain actions based on the tags. For example, if the system recognizes that a certain threshold has been overcome, it may then ask the user whether to implement a rule to automatically perform a certain action with respect to subsequent digital content, previously stored digital content, or both. In one example, the system may recognize that the user has tagged numerous recent photos with a contact name “Max.” The system may then query the user whether to automatically perform a certain function with respect to subsequent photos tagged with “Max,” such as automatically forwarding photos to Max (via an email address stored in the user's contact database), adding Max's phone number to a special calling plan or speed dial list, forwarding the photos to a blog or social networking site, and so forth.

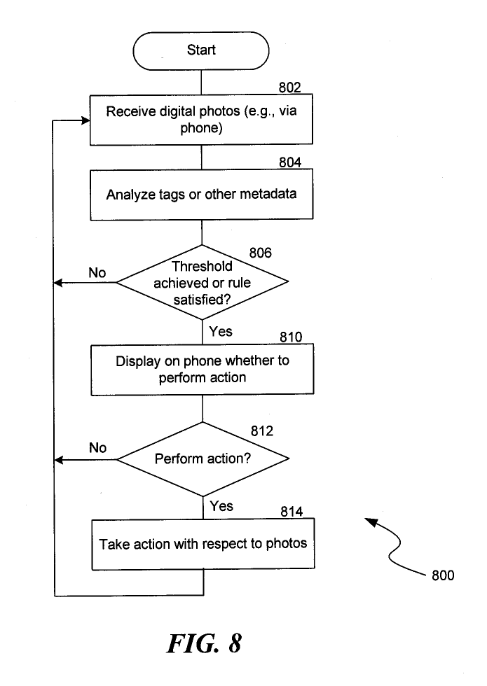

Referring to FIG. 8, an example of a routine 800 for automatically performing such an action begins in block 802 where the system receives digital photos. Such photos may be received at the phone, at the user's specified web page, or both. In block 804, the system analyzes the tags or metadata, and determines whether the tags exceed a threshold (block 806). If the tags do exceed a threshold (e.g., the number of similar tags exceed a numeric threshold), then in block 810 the system displays to the user whether to perform an action, as noted above. If the user responds affirmatively (block 812), then the system takes the appropriate action with respect to those photos. While much of routine 800 may be performed on the phone, some or all of it may be performed via the server 116 and the user's computer 124 by accessing the user's specific web page for storing digital content.

Likewise, while the processes are described above as presenting queries to the user on the mobile phone based on photos received at that phone, the system can alternatively or additionally, present such images in queries to the user at, for example, the user computer 124. Thus, the user may access her web page to view her photos, and then at that time receive a query from the server 116 whether to tag newly added photos with tags automatically gathered from the user's contact lists, calendar, location data, etc.

The server 116 may store in the database 118 more detailed records of the user and contacts for the user. An example of such a record, which may be stored in the database 118, can include the following fields:

| Field | Value |
|---|---|
| IMEI/IMSI | Integer |
| MIN | Integer |
| MAC | Integer |
| First Name | Alphanumeric |
| Last Name | Alphanumeric |
| Home Street Address | Alphanumeric |
| Home City | Alphanumeric |
| Home State | Alphanumeric |
| Home Postal Code | Alphanumeric |
| Home Neighborhood | Alphanumeric |
| Work Name | Alphanumeric |
| Work Street Address | Alphanumeric |
| Work City | Alphanumeric |
| Work State | Alphanumeric |
| Work Postal Code | Alphanumeric |
| Work Neighborhood | Alphanumeric |
| Email Address | Alphanumeric |
| User Image/Background | Image File |
| Instant Messaging Handle | Alphanumeric |
| User Name Alias | Alphanumeric |
| Phone Model Number | Alphanumeric |
| Camera MAC Address | Integer |
| Camera Model ID | Alphanumeric |
| Photo Web Site URL | Alphanumeric |
| Billing Plan | Alphanumeric |

As shown above, the record may include not only postal addresses for home and work, but also the neighborhood in which the contact's home and work are found. Some of the fields may not be viewed or edited by anyone without administrative privileges, such as the IMEI/IMSI, MAC, etc.

As shown above, a billing plan may be associated with a contact. This billing plan can indicate whether preferred billing is to be associated with this contact. For example, one billing plan may provide for reduced or free calling for certain phone numbers. Thus, in the example above, if the system recognizes that the user frequently takes pictures of “Max,” then the system asks whether this person should be added to the user's preferred billing plan.

### Web Interface for Managing Photos

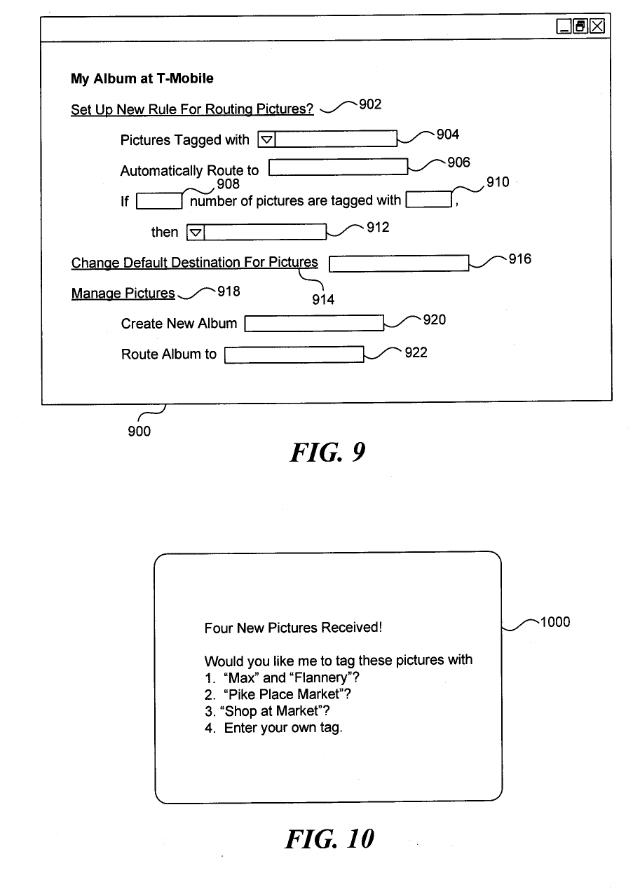

Referring to FIGS. 9 through 10, representative computer displays or web pages will now be described with respect to managing digital content, such as photos. The screens of FIGS. 9 through 10 may be implemented in any of various ways, such as in C++ or as web pages in XML (Extensible Markup Language), HTML (HyperText Markup Language) or any other scripts or methods of creating displayable data, such as the Wireless Access Protocol (“WAP”). The screens or web pages provide facilities to present information and receive input data, such as a form or page with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database typically connected to a server. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

Referring to FIG. 9, an example of a web page or screenshot 900 is shown that provides a graphical user interface for users to manage their images. As shown, a link 902 permits a user to set up a new rule for routing pictures, where the link accesses another page (not shown) for providing the user with the ability to adjust or modify details regarding automatic routing for images. However, the screen 900 provides some more common routing features, such as allowing a user to access a list of common metadata tags associated with images from a dropdown list 904 (e.g., date/time tags, location tags, etc.), and have images so tagged to be automatically routed to a specific logical address that may be inserted in box 906. Likewise, the user can specify that if a certain number of pictures (input to box 908) are tagged with a specific term (input to box 910), then a specified action is to be performed, where the action is selected from a dropdown list 912.

The user can change the default destination for his or her pictures by accessing a hyperlink 914 that in turn displays a page (not shown) for providing details on a new destination. However, the page 900, for convenience, provides a simple box 916 to allow the user to change the default destination, as noted herein. Likewise, a manage pictures link 918 allows access to a screen or page (not shown) for displaying many options to allow the user to manage pictures. However, the page 900 provides easy access to at least two simple and common management tools, namely the ability to create and name a new album in box 920, or to route an album via box 922. For example, the user may create a new album, insert pictures into that album, and then route the album to a designated location, such as a Facebook or MySpace page.

Referring to FIG. 10, an example of a screen that may be displayed, for example, on the mobile phone 104 is shown as screen 1000. This screen may be displayed to the user when the mobile phone receives new pictures to be tagged. As shown, the screen asks whether the user wishes to provide tags by selecting one of four numerical menu choices. The first option is whether to add displayed names of individuals obtained under process 500. Option 2 asks the user whether to add a displayed location name based on the routine 700. Option 3 asks the user whether to tag the newly received photos based on a corresponding appointment or calendar entry, under routine 600. Any of these choices may lead to a second screen (not shown) where the user can edit the displayed tags. A fourth option allows the user to enter manually a new tag.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while aspects of the invention are described above with respect to capturing and routing digital images, any other digital content may likewise be managed or handled by the system provided herein, including video files, audio files, and so forth. While processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges

The teachings of the invention provided herein can be applied to other systems, not necessarily the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

I/We claim:

1. A digital content sharing system, wherein the digital content sharing system may be used with a cellular telecommunications network and a Internet Protocol (IP) based computer network, the system comprising:
a digital image capture apparatus comprising:
optics and image capture circuitry,
image capture input and output components,
a short-range wireless transceiver, and
at least one image capture processor coupled to communicate with the optics and image capture circuitry, the image capture input and output components, and the short-range wireless transceiver, and
a first hand-held housing for carrying the optics and image capture circuitry, the image capture input and output components, the short-range wireless transceiver, and the at least one image capture processor; and,
a mobile telecommunications device comprising:
user input and output components,
a first wireless transceiver component for communicating with the short-range wireless transceiver,
a second wireless transceiver component for communicating with the wireless telecommunications network,
at least one processor coupled to communicate with the user input and output components, the first wireless transceiver component, and the second wireless transceiver component, and
a second hand-held housing, separate from the first housing, for carrying the user input and output components, the digital memory, the first wireless transceiver component, the second wireless transceiver component, and the at least one processor;
wherein the cellular telecommunications network has a range greater than that of the short-range wireless transceiver,
wherein the digital image capture apparatus is configured to capture a digital image via the optics and image capture circuitry, and to forward the captured digital image directly to the mobile telecommunications device via the short-range wireless transceiver, and
wherein the mobile telecommunications device is configured to:
receive the captured digital image via the at least one wireless transceiver,
obtain information related to the captured digital image,
associate at least one metadata tag with the captured digital image based on the related information, and
forward the captured digital image and associated metadata tag to the cellular telecommunications network, wherein the cellular telecommunications network in turn forwards the captured digital image and associated metadata tag to a designated network address on the IP based computer network.

2. The digital content sharing system of claim 1, wherein the digital image capture apparatus is a digital camera, wherein the short-range wireless transceiver is formed on a removable card received within a memory card slot of the digital camera, wherein the short-range wireless transceiver includes a Bluetooth radio, and
wherein the mobile telecommunications device is a cell phone, wherein the first wireless transceiver component includes a Bluetooth radio paired to the digital camera's Bluetooth radio, wherein the network address is a universal resource locator (URL), and wherein the IP based computer network is the World Wide Web.

3. The digital content sharing system of claim 1, wherein the mobile telecommunications device is further configured to associate at least one metadata tag with the captured digital image based on the related information by at least two of the following:
obtaining a name of a location based at least in part on geographic positioning signals received via the at least one wireless transceiver, and a comparison of a database that matches geographic position with corresponding location names; or
obtaining a name of at least one person or location based at least in part on at least one digital identifier received via the at least one wireless transceiver from at least one nearby wireless transmitter, and a comparison of a database that matches digital identifiers with corresponding names; or
obtaining a name of at least one person, location, or event based at least in part on at least one calendar entry, wherein the calendar entry is automatically obtained from an electronic calendar application associated with a user of the mobile telecommunications device.

4. The digital content sharing system of claim 1, wherein the digital image capture apparatus is a digital camera configured to capture still images, video images, or both, wherein the mobile telecommunications device is a cellular phone having an integrated digital camera, and wherein the digital camera produces higher resolution or quality images than the cellular phone's digital camera.

5. The digital content sharing system of claim 1, wherein the digital image capture apparatus further comprises image capture memory, and the at least one image capture processor is further coupled to communicate with the image capture memory, and the first hand-held housing further carries the image capture memory.

6. A method of associating metadata tags with digital content, the method comprising:
at a wireless mobile device, receiving captured digital content;
at the wireless mobile device and using a short-range wireless protocol, automatically and wirelessly receiving at least one digital identifier associated with at least one short-range wireless device within range of the mobile device when the captured digital content is received,
wherein the short-range wireless protocol has a range shorter than that of a protocol used within a cellular network in which the mobile device operates;
automatically obtaining a name associated with the short-range wireless device from a comparison of the received digital identifier to a database of digital identifiers associated with respective names;
providing a display regarding whether to add a metadata tag of the obtained name to the captured digital content; and,
based on user input, automatically adding the metadata tag of the obtained name to the captured digital content.

7. The method of claim 6 wherein the mobile device and the wireless device are both cell phones, wherein the digital content is a digital photo captured via a digital camera, and wherein the short-range wireless protocol is the Bluetooth protocol.

8. The method of claim 6, further comprising querying a user of the mobile device whether to automatically perform a new action if a substantially similar metadata tag has been added to a certain number of individual digital content items, and wherein the new action comprises:
automatically forwarding certain digital content to a person associated with the metadata tag, or
automatically posting the digital content to a website not primarily associated with storage of digital content from the user, or
automatically adding an electronic address for a person associated with the metadata tag to a speed dial list or wireless service plan list.

9. The method of claim 6, further comprising providing to a user of the wireless mobile device an advertisement associated with the metadata tag.

10. The method of claim 6, further comprising querying a user of the wireless mobile device whether to automatically add a metadata tag to a set of digital content items obtained at the wireless mobile device within a certain time interval or associated with a similar timestamp, wherein the querying is performed at the wireless mobile device.

11. The method of claim 6 wherein the predetermined network location comprises encapsulating a logical network address with the digital content, and wherein the logical address is associated with a web page for the user and related to an operator of the cellular network.

12. The method of claim 6 wherein the digital content comprises an audio file.

13. The method of claim 6, further comprising adding a user identifier and forwarding the obtained name and the captured digital content to a predetermined network destination, wherein the network destination is accessible over a TCP/IP network via a Universal Resource Locator (URL), and wherein the user identifier comprises: a mobile identification number (MIN), International Mobile Subscriber Identifier (IMSI), International Mobile Equipment Identifier (IMEI), Secret Serial Number (SSN), phone number, Medium Access Control (MAC) address, or Globally Unique Identifier (GUID).

14. The method of claim 6 wherein the providing a display comprises providing the display on the mobile device.

15. An article of manufacture, wherein the article of manufacture comprises a computer-readable medium carrying instructions for use by a wireless telecommunications device, wherein the instructions, when executed by the wireless telecommunications device permit the device to perform a method, the method comprising:
wirelessly receiving at the wireless telecommunications device still digital images, moving digital images, or both, directly from a digital camera or digital camcorder;
displaying the received digital images at the wireless telecommunications device;
receiving at the wireless telecommunications device at least one user-input metadata tag related to at least the received digital images; and,
either storing the at least one user-input metadata tag associated with the digital images at the wireless telecommunications device, or wirelessly transmitting, from the wireless telecommunications device, the at least one user-input metadata tag for storage with digital images.

16. The article of manufacture of claim 15 wherein the wireless telecommunications device is a cell phone, wherein the cell phone is configured to communicate with both a cellular network using a longer range cellular network protocol and with the digital camera or digital camcorder using a shorter range wireless protocol, wherein the wirelessly receiving includes wirelessly receiving from the digital camera or digital camcorder the digital images using the shorter range wireless protocol, and wherein the wirelessly transmitting comprises wirelessly transmitting the at least one user-input metadata tag to the cellular network using the longer range cellular network protocol.

17. The article of manufacture of claim 15 wherein receiving the user-input metadata tag comprises:
automatically receiving at least two different metadata tags for the received digital images, wherein the two metadata tags include a person's name from a contacts database, a location name based on location coordinates, or an event from an electronic calendar application;
presenting the at least two metadata tags to request user input; and
receiving user input selecting at least one of the two metadata tags.

18. An apparatus configured for processing digital content, the apparatus comprising:
means for receiving digital content;
means for automatically obtaining tags related to the received digital content;
means for querying a user whether to associate the tags with the digital content; and,
means for associating the tags with the digital content based on received user input.

19. The apparatus of claim 18 wherein the means for automatically obtaining tags includes means for obtaining a name of a location based at least in part on received geographic positioning signals and a comparison of a database that matches geographic position with corresponding location names.

20. The apparatus of claim 18 wherein the means for automatically obtaining tags includes means for obtaining a name of at least one person or location based at least in part on a received digital identifier and a comparison of a database that matches digital identifiers with corresponding names.

21. The apparatus of claim 18 wherein the means for automatically obtaining tags includes means for obtaining a name of at least one person, location, or event based at least in part on an electronic calendar entry associated with a user of the apparatus.

22. A method of processing still digital images, moving digital images, or both, the method comprising:
receiving digital images representing captured still or moving digital images;
receiving a timestamp associated with the captured still or moving digital images, location data associated with the captured still or moving digital images, or a wirelessly transmitted electronic identifier received when the captured still or moving digital images were captured;
automatically obtaining a tag for associating with the captured still or moving digital images, wherein the tag relates to: an appointment from an electronic calendaring application and related to the timestamp, a location name corresponding to the location data, or a person's name or location name associated with the wirelessly transmitted electronic identifiers; and,
automatically providing a user query regarding whether to logically associate the tag with the captured still or moving digital images.

23. The method of claim 22 wherein the location data is GPS or GIS data, wherein receiving digital images comprises:
storing on a remote database the captured still or moving digital images, and
displaying a representation of the captured still or moving digital images on a user computer via a web page, and
wherein automatically providing the user query comprises:
providing a web page for display on the user computer, wherein the web page lists multiple tags and ask whether to associate any of the multiple tags with the captured still or moving digital images.
